(19) United States
(12) Patent Application Publication
(10) Pub. No.: US 2017/0242235 A1
(43) Pub. Date: Aug. 24, 2017

(54) SYSTEM AND METHOD FOR EMBEDDED IMAGES IN LARGE FIELD-OF-VIEW MICROSCOPIC SCANS

(71) Applicant: ViewsIQ Inc., Richmond (CA)

(72) Inventors: Sebastien LALLEMENT, Vancouver (CA); Thomas LE GUERROUE DREVILLON, Richmond (CA); Li-Heng LIN, Vancouver (CA); Hok Man Herman LO, Richmond (CA); Abtin RASOULIAN, Vancouver (CA)

(21) Appl. No.: 15/504,576

(22) PCT Filed: Aug. 17, 2015
(86) PCT No.: PCT/CA2015/050779

§ 371 Date: Feb. 16, 2017

Related U.S. Application Data
(60) Provisional application No. 62/038,499, filed on Aug. 18, 2014.

(51) Int. Cl. G02B 21/36; G06K 9/62; G06T 7/11; G06T 11/60; G06T 7/73

(52) U.S. Cl. CPC G02B 21/367; G06T 11/60; G06T 7/73; G06T 7/11; G06K 9/6202; G06T 2207/10056

(57) ABSTRACT

A method and system are provided for acquiring and combining images captured by a microscope. The method comprises: capturing a new image from the microscope using an imaging device; comparing the new image against a previous image to provide an estimated position of the new image; identifying neighboring key frames of a scan stored in memory based on the estimated position of the new image; comparing the new image to the identified key frames to determine a relative displacement of the new image from the neighboring key frames; and determining a position of the new image based on the relative displacement of the new image. The system includes: a microscope; a camera coupled to the microscope for capturing images through the microscope; and a computing device coupled to the camera, the computing device comprising: a memory; and a processor configured and adapted to perform a method as described herein.

### BACKGROUND

In many clinical studies, the acquisition of large-field-of-view microscopic images is extremely beneficial. Many techniques are proposed using automated microscopes [1] or manual stage microscopes [2]. In this document, a scan is referred to as a large image covering a large field-of-view of a specimen. A scan may be composed of many smaller images, such as in FIG. 1A, or a unified image of a specimen such as in FIG. 1B. In FIG. 1A, the smaller images are referred to as keyframes. The relative locations of the keyframes are known a-priori. This may be performed using automatic scan system or image-based techniques [2]. Without loss of generality, for the rest of this document, it is assumed that a scan is composed of many keyframes with the same size.

### BRIEF DESCRIPTION OF THE DRAWINGS

Embodiments of the present disclosure will now be described, by way of example only, with reference to the attached Figures.

FIG. 1A is an illustration of a scan of a specimen comprising many smaller images;

FIG. 1B is an illustration of a scan of a specimen comprising a single unified image;

FIG. 2 is an illustration of a scan having embedded scans;

FIG. 3 is a schematic diagram of a system, in accordance with an embodiment of the present disclosure;

FIG. 4A is an illustration of a first scan with a new image captured by an objective with a magnification smaller than that of the original scan;

FIG. 4B is an illustration of a first scan with a new image capture by an objective with a magnification larger than that of the original scan;

FIG. 5 is a flowchart diagram illustrating a process of localizing an image, in accordance with an embodiment of the present disclosure;

FIG. 6 is a flowchart diagram illustrating the process for determining the localization information for a frame, in accordance with an embodiment of the present disclosure;

FIG. 7 is a schematic representation of the selection of key frames in various iterations of an exhaustive search, in accordance with an embodiment of the present disclosure;

FIG. 8 is a schematic representation of the process of correcting relative magnification;

FIGS. 9A and 9B illustrate a user interface of multi-objective scans, in accordance with an embodiment of the present disclosure;

FIG. 10 is a schematic diagram illustrating a system setup for recording Z-stack manually, in accordance with an embodiment of the present disclosure;

FIG. 11 is an illustration of a user interface for viewing a Z-stack, in accordance with an embodiment of the present disclosure;

FIG. 12 is an illustration of a user interface for viewing a scan, in accordance with an embodiment of the present disclosure; and

FIG. 13 is an illustration of a user interface for viewing a scan showing the location of Z-stacks, in accordance with an embodiment of the present disclosure.

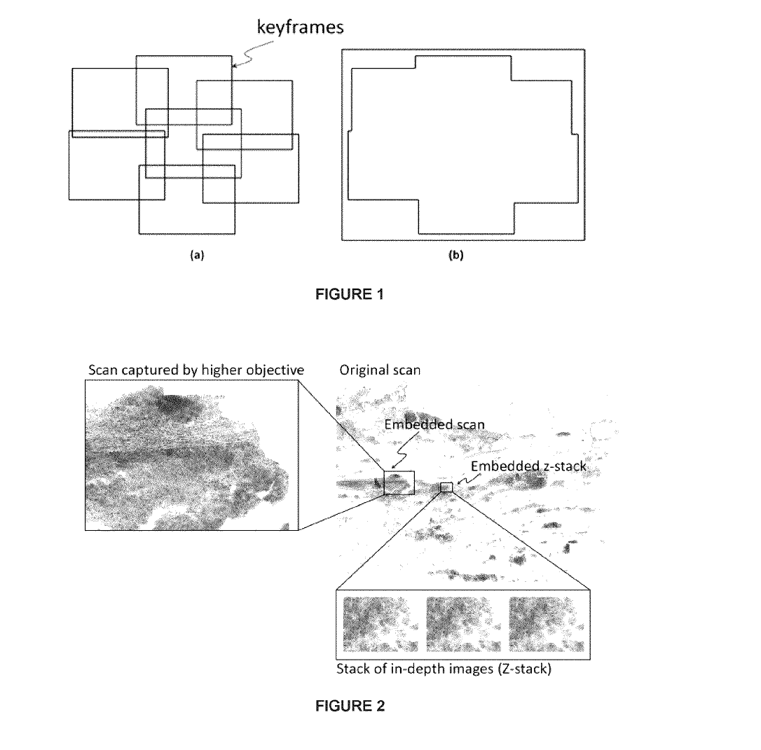

### DETAILED DESCRIPTION

### Introduction

### Problem Definition

Given the common use case, it can be beneficial to a technologist or a clinician to observe some part of the specimen in more resolution or explore a portion in z-axis. In other words, it would be beneficial to embed other images which are acquired with different magnification or depth into the main scan. The images are either a collection of images acquired by moving the stage spatially, or acquired by changing the focus of the microscope. For the rest of this document, the former is referred to as multi-objective scanning while the latter is referred to as Z-stack. Note that a prerequisite for such features are accurate localization of the images that are acquired by any arbitrary objectives within a large field-of-view scan. FIG. 2 shows a scan with embedded scan captured with high magnified objective and a Z-stack. As shown in FIG. 2, an original scan may contain another scan which is captured with different objective magnification, or may have Z-stacks, which are images captured with different focus/depth.

The above mentioned features, together with the live acquisition of the images, are provided in microscopes with a motorized stage but are not available in manual stage microscopes. Some embodiments described herein rate to a system that collectively provides these features.

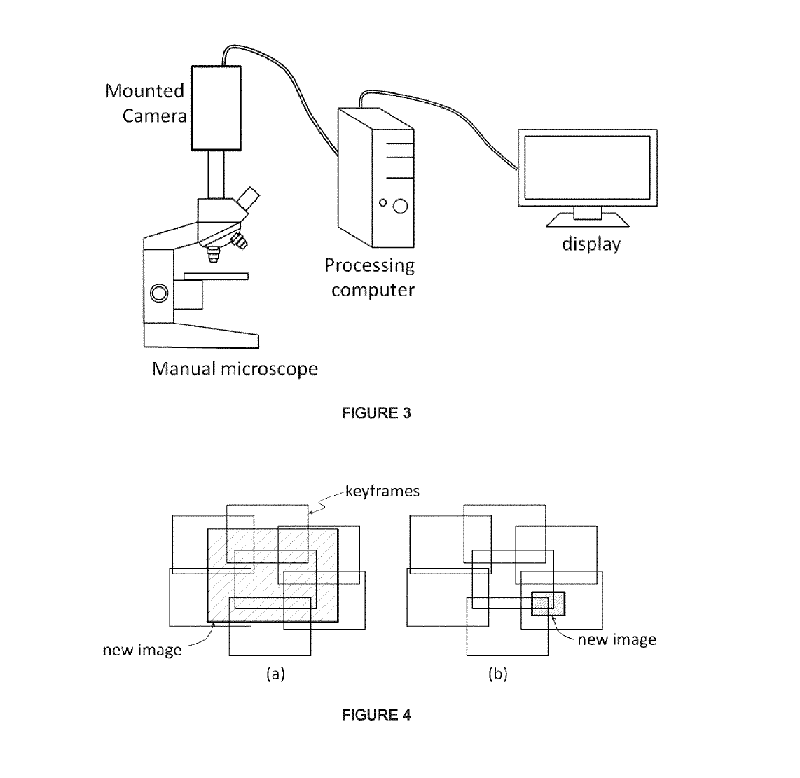

In the present disclosure, it is assumed that the stream of images are acquired from a camera mounted on a manual microscope, providing a live digital image of the specimen. The latest digital image of the camera is referred to as the current image frame hereafter. The user has control over the manual stage and the focusing of the microscope. The user notifies the system when he/she switches the objective. The system then automatically localizes the live images within the already captured scan. The user may also notify the system when he/she intends to change the focus to acquire Z-stacks. FIG. 3 shows the overview of the system hardware. As shown in FIG. 3, a camera is mounted on a manual microscope which streams real-time images to a processing computer. Images are processed in real-time and the visualization is performed on the display.

This disclosure will cover three aspects of the embodiments disclosed herein. First, the localization of an image within a scan, which is presented in the “Multi-objective localization” section. Second is the proposed system for stitching and embedding such scans at different objectives within the original scan, which is presented in the “Multi-objective scanning” section. The third, is the proposed system for storing and managing Z-stacks embedded within a scan, which is illustrated in the “Z-stack” section.

### MULTI-OBJECTIVE LOCALIZATION

Given a scan, the multi-objective localization is defined as the localization of a stream of images captured by an objective different from the objective that is used in the reconstruction of the scan. FIGS. 4A and 4B show the two different scenarios, where the image (shown with stripes) is captured using a larger magnification or a smaller magnification. In FIG. 4A, the current image frame is captured by an objective with magnification smaller than that of the original scan. In FIG. 4B, the current image frame is captured by an objective with magnification larger than that of the original scan. The image may have overlap with one or more keyframes of the scan. The image originally has the size (Sₓ, S_{y}), but can be scaled by relative magnification to the original scan. For example, if the original scan is captured by a 10× objective and the current image frame is captured by a 40× objective, the image can be scaled by a factor of 0.25. The location of the current frame which is captured at time t, with respect to the original scan, is represented by Pₜ.

The localization is performed via a series of image matching. In the next section the matching process is explained.

### Registration of Two Frames

### Feature Detection

Feature detection is performed on the current image frame. The features are used for image registration (linking) The result of the feature detection is a set of features, where each may include a set of properties:
Position in image coordinate (x, y);
Geometrical properties such as scale and orientation;
Image properties that are used to describe the image pattern around the feature.

### Matching Two Frames

Matching of frames is performed by matching their features. Many techniques are proposed for this purpose [2] [3]. Assuming that a long list of features is detected in both images, this part contains two steps (the frames are referred to as reference and matching frames):

1. For each feature in the reference frame, the closest feature in the matching frame is found. The closest feature should have the most similar properties.

2. A displacement is collectively found based on the matched features.

### Definition of Tracking, Linking, and Localization

Given the stream of images, the term tracking in this document refers to the matching of the current frame to the previous frame. Assuming that the matching results in a displacement of d, the location of the current frame is estimated as Pₜ=Pₜ₋₁+d. The current frame is called tracked if it is successfully matched to the previous frame.

The term “linking” as used herein refers to the matching of the current image frame to a keyframe. The current image frame is called linked, if it is successfully matched to at least one of the keyframes.

The term “localization” as used herein refers to determining whether the current frame location is correct based on the tracking and linking The current image frame is called localized, if its location in the scan is correct.

### Localization Process

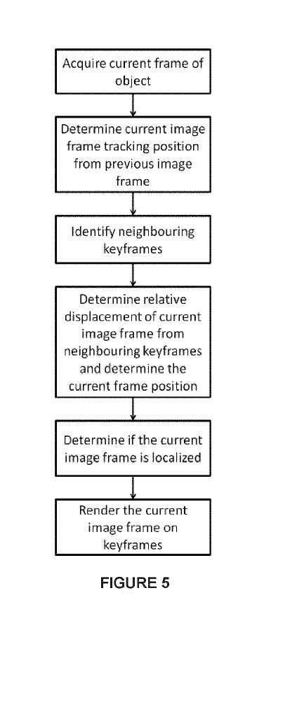

The localization process, which is a process of the localization of the current image frame within keyframes that are acquired with different objective magnification, is shown in FIG. 5 and is outlined as follows:

1. The current image frame is preprocessed and the features are extracted.

2. The position, [symbol] (x_^{—}ₜ, yₜ) sᵢ of features in the new frame are scaled according to the difference in magnification of this frame and keyframes. Assuming that the new frame has a magnification of in and the keyframes have a magnification of mₖ.

Therefore, the position and scale are scaled as follows:

3.

$$( {\hat{x}}_{i} , {\hat{y}}_{i} ) = ( \frac{{m}_{k}}{{m}_{n}} \times {x}_{i} , \frac{{m}_{k}}{{m}_{n}} \times {y}_{i} ) and {\hat{s}}_{i} = \frac{{m}_{k}}{{m}_{n}} \times {s}_{i} .$$

estimate

4. Linking. Next, the current image frame is matched to the neighbouring keyframes to correct its location and remove the possibility of accumulation of inaccurate matching resulted from Tracking.

The linking may not always be successful in the case of multi-objective matching. Therefore the tracking information is combined with the linking information to determine the location of the current frame. The process is described in the next section.

### Combining the Tracking and Linking for Accurate Localization

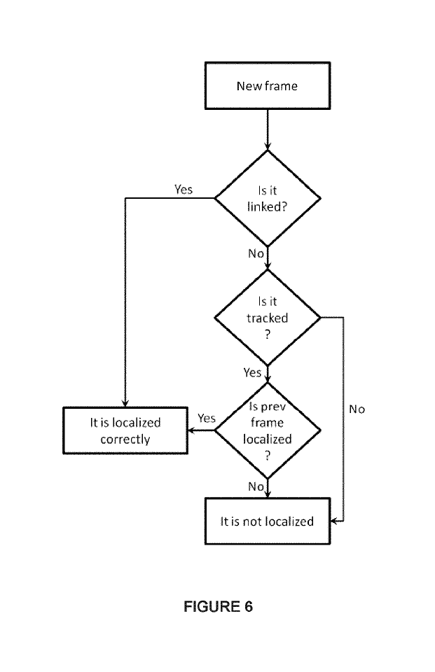

The position of the current image frame is estimated based on the linking and tracking information. The current image frame is localized if it is linked or tracked and the previous image frame is localized. The logic is shown in FIG. 6, which is a diagram describing the combination of the tracking and linking information for accurate localization of the current image frame. Differences in the optical properties of objectives may introduce changes in the image. These changes may cause matching of images between objectives to fail. To improve robustness of the localization algorithm, tracking can be added to the algorithm as an alternate method for image localization.

### Exhaustive Search

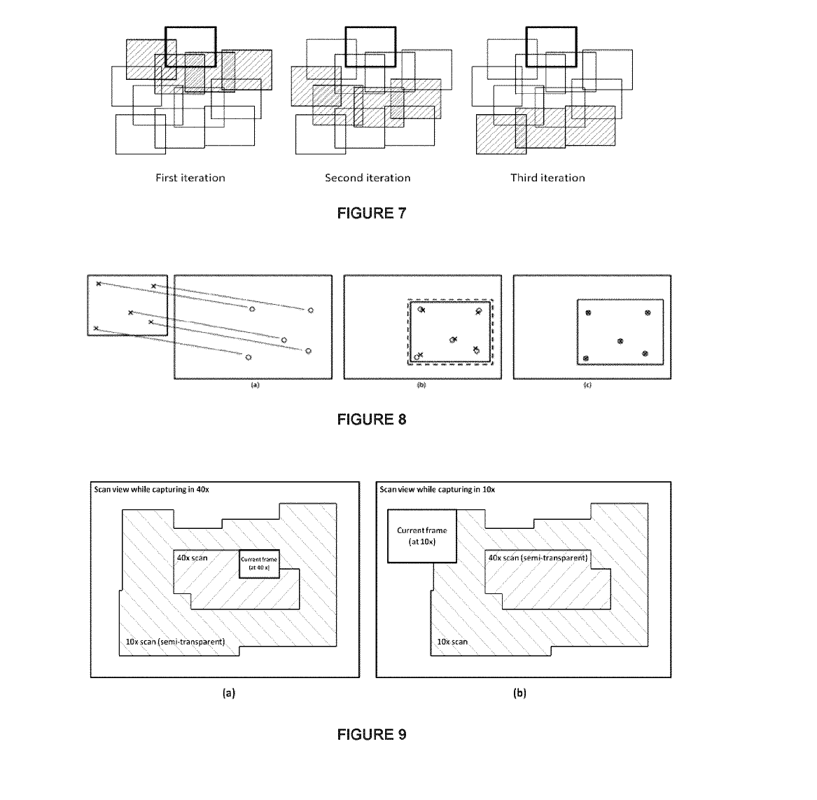

If the current image frame is not localized in the previous step, the algorithm enters the exhaustive search state. At this step, keyframes are sorted according to their distance to the current image frame. As opposed to the previous step, not all but only a portion of these keyframes are linked to the frame at this point. This is performed to prevent exhaustive search from hindering the real-time performance of the system. Assuming that keyframes are sorted based on their distance to the current image frame: K₀, K₁, . . . , Kₙ₋₁. The first time at the exhaustive search, only the first m elements K₀. . . , Kₘ₋₁ are processed. If the linking is not successful, for the next frame, the second m elements Kₘ, . . . , K₂ₘ₋₁ are processed (see FIG. 7) and so on. FIG. 7 illustrates exhaustive search in case the current image frame is not localized within its neighboring keyframes; all the keyframes are sorted with respect to their distance to the current image frame and, at each iteration, only a portion of keyframes are examined for localization of the current image frame. Since the current image frame is updated at each iteration, the reference frame does not remain the same. However, one can assume that they don't move as much since the exhaustive search can visit all the keyframes in a fraction of a second.

### Correction of the Relative Magnification

The magnification indicated on an objective may not be exactly true. For example a 10× objective may have a magnification of 10.01. A true magnification can be achieved using physical calibration. However in absence of such information, one can find the “relative” magnification between different objectives in the process of image matching.

Assuming that some of the features in the keyframe and the current image are correctly matched to each other. Note that each feature has a position and can be represented as a point. Matched features in the reference frame can be listed as r₁, . . . , rₙ, and matched features in the matching frame can be listed as m₁, . . . , mₙ. The features with the same indices are matched, i.e. rᵢ corresponds to mᵢ. FIG. 8 shows such correspondences and also our previous approach to find the displacement between the two frames. As shown in FIG. 8, which illustrates correction of the relative magnification, this can be performed via Procrustes analysis [4] that is performed on the matched features of the current image frame and the matching keyframe. Although the frames are almost matched after displacement, the relative scale still exists between two frames. Therefore, the relative scale between two frames should be recalculated properly. Assuming that each point has both x and y components: rᵢ=[xᵣ_{ᵢ}, yᵣ_{ᵢ}]. Initially the average of all components is calculated:

$${\overline{x}}_{r} = \frac{\sum {x}_{{r}_{l}}}{n} , \qquad {\overline{y}}_{r} = \frac{\sum {y}_{{r}_{l}}}{n} , \qquad {\overline{x}}_{m} = \frac{\sum {x}_{{m}_{l}}}{n} , \qquad {\overline{y}}_{m} = \frac{\sum {y}_{{m}_{l}}}{n}$$

Next, the scale for each point set is calculated:

$${s}_{r} = \sqrt{\frac{{\sum }_{i = 1}^{n} {( {x}_{{r}_{i}} - {\overline{x}}_{r} )}^{2} + {( {y}_{{r}_{i}} - {\overline{y}}_{r} )}^{2}}{n}} , {s}_{m} = \sqrt{\frac{{\sum }_{i = 1}^{n} {( {x}_{{m}_{i}} - {\overline{x}}_{m} )}^{2} + {( {y}_{{m}_{i}} - {\overline{y}}_{m} )}^{2}}{n}} .$$

The true relative magnification is then calculated as

$$( \frac{{s}_{r}}{{s}_{m}} ) \times S ,$$

where S is the relative magnification which was calculated originally based on a priori knowledge of the objectives. For example for 10× and 40× objectives, S=0.25.

### MULTI-OBJECTIVE SCANNING

### Linking Multiple Scans

The user can select to stitch the images captured with a different objective and create another scan. Many techniques are proposed for such stitching [2]. In this situation, a parent-child relation is established between this scan and the original scan. A link is set up between two scans to relate the corresponding coordinate spaces. Assuming that n frames are captured at the child scan. The stitching of these frames results in the positions of (x₁, y₁), . . . , (xₙ, yₙ). Also, by using multi-objective localization, the positions of these frames within the parent scan are found: (X₁, y₁), . . . , (xₙ, yₙ). To relate these coordinate spaces, one can use Procrustes analysis [4], where the unknowns are the translation and the scale.

### User Interface

The user may switch to a different objective at any time. The user may also start scanning at the selected objective. At this point the previous scan which was captured by the parent objective, is shown semi-transparently in the background. This will provide a visual aid for the user to relate two scans to each other. After finishing the scan, the user may switch back to the parent objective. At this point, the scan which was captured by the different objective, is shown semi-transparent and is clickable. By user clicks, the scan view switches to make the child scan active. That is, the 40× scan becomes opaque while the 10× scan becomes semi-transparent. FIGS. 9A and 9B show the overview of the user interface of the multi-objective scan, in which the user may switch between objectives and modify each scan separately while the other scan is visible semi-transparently.

Recording the Multi-Objective Scan

A parent scan and its child scans are saved using their own file format. The child scans can be linked to the parent scan using an additional file. Information such as the path to the child scan file and location of the child scan within the parent scan is recorded in this file.

### Z-STACK

The digitization of samples in microscopy is usually achieved by capturing a large 2D scan. While this solution satisfies most situations, it only allows to capture a narrow depth of field, stripping away valuable information for the analysis of certain samples. A solution to this problem is the capture of Z-stacks. A Z-stack is defined as a stack of images representing the same specimen at different focal planes. In theory, one could capture a Z-stack for an entire sample leading to a stack of scans. However, due to the high resolution of the images composing a scan, a stack of scans becomes unpractical as it necessitates too much memory space.

This section proposes a method for reducing the memory usage by recording Z-stacks covering a limited area of a specimen and attaching the stacks to a scan covering the entire sample. This solution has the advantage of providing enough depth information of a scan for analysis while keeping the memory usage low.

The section is divided into two parts. The workflow for recording and visualizing a Z-stack using a microscope is described in the first section and the attachment of the Z-stacks to a scan is explained in the second section.

### Z-Stack Recording

### Hardware Setup

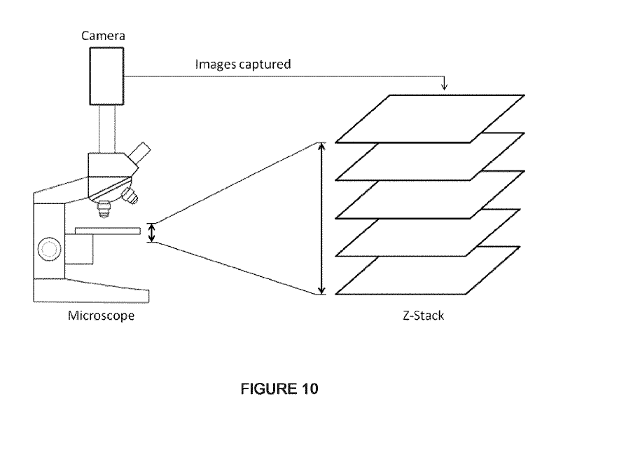

As shown in FIG. 10, a Z-stack can be recorded using a digital video camera that is mounted on a microscope. In FIG. 10, the system setup comprises a microscope on which is mounted a camera that captures images while the microscope stage is moved at different depths. While the camera is capturing a specimen placed under the microscope at fixed time interval, one can move the microscope stage so that the specimen is viewed at different depths. As a result, the images captured by the camera can be regrouped to form a stack of images representing the same location of a specimen at a range of depth only limited by the amount of stage movement occurred during the recording. Note that this method is not necessarily limited to the analysis of depth information and can be used to record a region of a sample by moving the stage laterally/spatially during the recording.

### Z-Stack Visualization

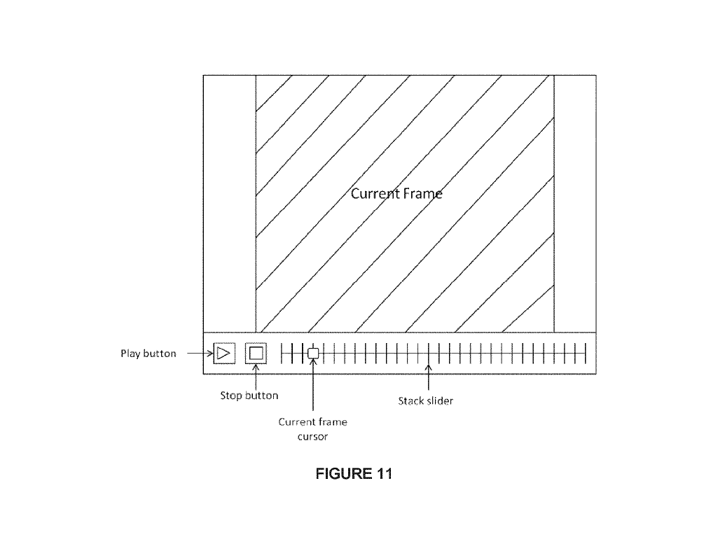

Z-stacks are visualized one frame at a time as shown in FIG. 11, which illustrates a user interface for viewing a Z-stack. There are different ways to go through a Z-stack. The first one is to play the Z-stack from beginning to end at the same speed (or a factor of the speed) as the recording speed in a similar way as playing a video. The second method is to scroll through the frames using the mouse's scroll wheel or dragging the current frame cursor with the mouse, allowing one to go either backward or forward along the Z-stack. The final method is to select any random frame to view within the stack using a slider as shown in FIG. 11.

Note that the user interface may have other features such as trimming the beginning and the end of a Z-stack. For example, the user who manually records a Z-stack clicks on the “Record” button in the software, takes some time to get ready on the user's microscope, and then drives the focus knob or stage to capture the focal planes and regions of interest. The captured frames in between these operations can be trimmed to reduce the size of a Z-stack.

Since a Z-stack can use a lot of memory space, it is difficult to keep in memory the entire stack that is being visualized. To accommodate this problem, it is possible to keep the Z-stack in a file saved on the hard drive and only load the frame that is currently being displayed. This, however, assumes that the file format used for saving Z-Stacks allows random access of frames within the stack. To resolve this issue, a saving technique is proposed in the next section.

### Saving a Z-stack

The Z-stacks containing high resolution images can become costly in terms of memory space. Compressing the images of the stack then becomes an important step in the recording of a Z-stack. As mentioned in the previous section, the images of a Z-stack may be visualized in any order directly from a file. The compression algorithm permits the decoding of random frames within a Z-stack. According, use of a standard video compression process is generally note suitable as such a process would compress images in a temporal manner, leading to the necessary dependency between neighbour images in the Z-stack. Although video compression algorithms offer great compression ratios, the decompression of any image n in a Z-stack would require decompression of the previous image n−1 which in turn would require the decompression of the previous images until the first frame of the Z-stack is reached. This method of decompression is only appropriate when reading a video in order from beginning to end. It is however not suitable for random access of frames throughout the Z-stack. One solution is to compress the frames of a Z-stack individually as separate images. This may not offer the best compression ratio but it satisfies the requirements for reading a Z-stack. These compressed images can then be saved in a multi-layered image file format such as TIFF.

### Attaching a Z-Stack to a Scan

A Z-stack alone may not provide enough information for analyzing a specimen as it covers a limited region of the sample. However, it becomes a powerful feature when localized within a scan. This part proposes an apparatus for embedding Z-stacks into a sample scan recorded manually using a microscope and a digital video camera.

### Z-Stack Recording

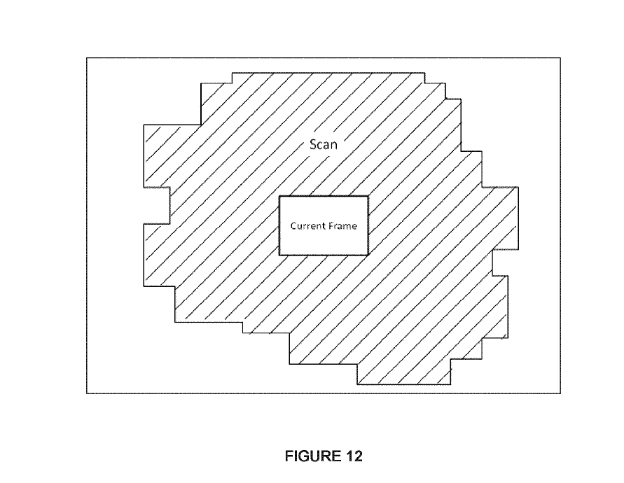

This section assumes we have a system for manually scanning a sample using a microscope and a digital camera. The user interface for such system comprises a view of the scan as well as the position of the current image frame captured by the camera as shown in FIG. 12. The box at the center shows the current position of the camera relative to the scan.

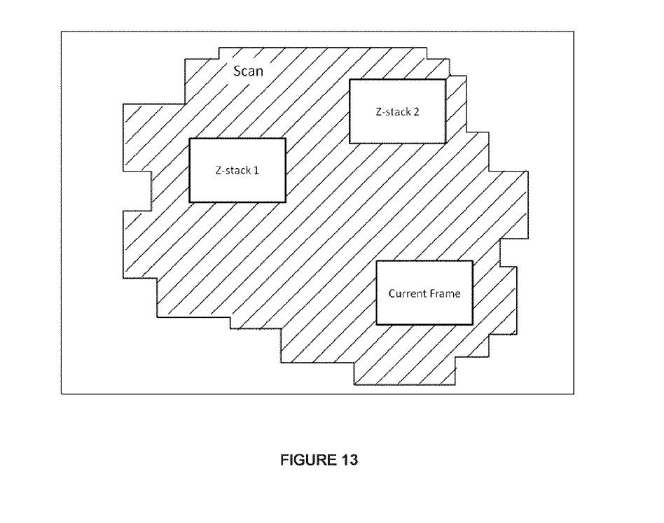

When a region of interest is found, the user can initiate the recording of a new Z-stack by clicking a button as described in “Z-stack Recording” section. When recorded, the position of the Z-stack is known using the localization algorithm of the manual scan system. Note that since the user is free to move the microscope stage laterally, the system sets the position of the entire Z-stack to the location of the first frame recorded. A link is established between the Z-stack and the scan by annotating the latter with a rectangle. The rectangle position and size matches the one of the Z-stack and can be clicked to open the Z-stack viewer described in “Z-stack Visualization” section (see FIG. 13). In FIG. 13, the Z-stacks are localized in the scan and shown as an outline rectangle with a semi-transparent image. These rectangles are clickable, which opens another window for viewing the Z-stacks.

The localization algorithm described in “Multi-objective localization” section only provides an estimate of the position of the current frame when recording a Z-stack using an objective lens with a different magnification than the one used for scanning This estimate cannot guarantee the accuracy of the position of the recorded Z-stacks. A solution to this issue is to allow the user to refine the position of a Z-stack relative to a scan by dragging the rectangle annotation representing the Z-stack within the scan using the mouse. Visual feedbacks can be provided to the user by drawing one of the images of the Z-stack semitransparent inside the rectangle annotation. This is beneficial as one could see the overlap between the Z-stack and the scan but it assumes that the frame drawn inside the rectangle is recorded at the same focal plane as the scan. There are several ways to ensure the chosen frame is as described. One can select the sharpest frame within the Z-stack to best match the scan, if the scan is carefully composed of sharp images. Another possibility is to always select the first frame recorded but it is assumed that the Z-stack is recorded starting from the same focal plane as the scan.

This is an acceptable assumption as the user will initiate recording once he/she finds a region of interest to record. The region can only be found by browsing the scan, which is moving the camera while staying at the same focal plane as the scan.

### Saving the Link Between a Z-stack and a Scan

Both the scans and the Z-stacks are saved using their own file format. This structure should be kept for flexibility. Therefore, an additional file should be created to store the relationship between a scan and the Z-stacks recorded into that scan. This file should contain the path names to the files of the scan and the individual Z-stacks. It should also contain the position of the Z-stacks relative to the scan.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

### REFERENCES

The following references are incorporated herein by reference in their entirety:

[1] “BZ-9000 All-in-one Fluorescence Microscope,” Keyence Corporation, [Online]. Available: http://www.keyence.com/products/microscope/fluorescence-microscope/bs-9000/index.jsp.

[2] H. a. L. L. a. C. B. a. A. M. a. L. S. LO, “Apparatus and method for digital microscopy imaging”. 2013.

[3] D. G. Lowe, “Object recognition from local scale-invariant features,” in The proceedings of the seventh IEEE international conference on Computer vision, 1999.

[4] G. D. J. C. Gower, Procrustes Problems, Oxford University Press, 2004.

1. A system comprising:
a microscope;
a camera coupled to the microscope for capturing images through the microscope;
a computing device coupled to the camera, the computing device comprising:
a memory; and
a processor configured and adapted to:
acquire a new image from the camera;
compare the new image against a previous image to provide an
estimated position of the new image;
based on the estimated position of the new image, identify neighboring key frames of a scan stored in memory;
compare the new image to the identified key frames to determine a relative displacement of the new image from the neighboring key frames; and
determine a position of the new image based on the relative displacement of the new image from the neighboring key frames.

2. The system of claim 1, wherein the processor is further configured to:
determine if the new image has been localized; and
if the image has not been localized, perform an exhaustive search to determine a location of the new image.

3. The system of claim 2, wherein the exhaustive search is performed in iterations by selecting a portion of the key frames in each iteration and comparing the new image against the selected portion of key frames.

4. The system of claim 1, further comprising a display coupled to the computing device;
wherein the processor is further configured to render the scan and the new image on the display.

5. The system of claim 1, wherein the processor is further configured to embed the new image in an existing scan.

6. The system of claim 1, wherein the processor is further configured to embed a z-stack in an existing scan, the z-stack being a set of images of the sample captured at different depths.

7. The system of claim 6, wherein the processor is further configured to compress the z-stack in a manner to permit random access of each image in the z-stack.

8. The system of claim 1, further comprising an input device; wherein the processor is further configured to accept user input to move an embedded image relative to the existing scan.

9. A method of acquiring and combining images captured by a microscope, the method comprising:
capturing a new image from the microscope using an imaging device;
comparing the new image against a previous image to provide an estimated position of the new image;
identifying neighboring key frames of a scan stored in memory based on the estimated position of the new image;
comparing the new image to the identified key frames to determine a relative displacement of the new image from the neighboring key frames; and
determining a position of the new image based on the relative displacement of the new image.

10. The method of claim 9, further comprising:
determining if the new image has been localized; and
if the image has not been localized, performing an exhaustive search to determine a location of the new image.

11. The method of claim 10, wherein the exhaustive search is performed in iterations by selecting a portion of the key frames in each iteration and comparing the new image against the selected portion of key frames.

12. The method of claim 9, further comprising rendering the scan and the new image on a display.

13. The method of claim 9, further comprising embedding the new image in an existing scan.

14. The method of claim 9, further comprising embedding a z-stack in an existing scan, the z-stack being a set of images of the sample captured at different depths.

15. The method of claim 14, further comprising compressing the z-stack in a manner to permit random access of each image in the z-stack.

16. The method of claim 9, further comprising detecting user input at an input device and moving an embedded image relative to the existing scan in response to the user input.

17. A non-transitory computer-readable memory storing statements and instructions for execution by a processor to perform operations for acquiring and combining images captured by a microscope, the operations comprising:
capturing a new image from the microscope using an imaging device;
comparing the new image against a previous image to provide an estimated position of the new image;
identifying neighboring key frames of a scan stored in memory based on the estimated position of the new image;
comparing the new image to the identified key frames to determine a relative displacement of the new image from the neighboring key frames; and
determining a position of the new image based on the relative displacement of the new image.
